(19) United States
(12) Patent Application Publication
(10) Pub. No.: US 2018/0320706 A1
(43) Pub. Date: Nov. 8, 2018

(54) COMPOSITE AIRFOIL WITH METAL STRENGTH

(71) Applicant: General Electric Company, Schenectady, NY (US)

(72) Inventors: Nitesh Jain, Bangalore (IN); Sujana Chandrasekar, Kundalahalli (IN); Ramkrishna Maripalli, Bangalore (IN); Nicholas Joseph Kray, Mason, OH (US); Wendy Wenling Lin, Montgomery, OH (US)

(21) Appl. No.: 15/586,662

(22) Filed: May 4, 2017

(51) Int. Cl. F04D 29/38; B32B 5/02; B32B 37/14; F02C 3/04; F04D 29/32

(52) U.S. Cl. CPC F04D 29/388; B32B 5/02; B32B 37/14; F02C 3/04; F04D 29/325; B32B 2305/076; F05D 2300/174; B32B 2262/106; B32B 2262/103; F05D 2300/6032; F05D 2220/32; F05D 2300/171; F05D 2300/177; B32B 2605/18

(57) ABSTRACT

A laminated composite airfoil assembly includes a first lamina formed of a pre-preg material including metal fibers, and at least a second lamina formed of a pre-preg material including at least one of metal fibers intermixed with carbon fibers, only metal fibers, only carbon fibers, a substrate including metal fibers, a substrate including carbon fibers, and combinations thereof.

### BACKGROUND

The field of the disclosure relates generally to gas turbofan engines and, more particularly, to a gas turbofan engine including composite airfoils with metal strength.

At least some known airfoil assemblies or fan blades for turbofans, such as those implemented in aircraft engines, are formed using composite components, such as carbon fibers plies. At least some of these laminated airfoils fabricated from carbon fiber include one or more metal pieces coupled thereto after the airfoils are fabricated. For instance, at least some known carbon fiber fan blades include a metal piece coupled to the leading edge of the blade, in order to increase impact capabilities of the fan blade. However, these metal pieces add weight to each airfoil. As reducing engine weight is a constant driver in aircraft engine design, it would be beneficial to reduce the weight of airfoils while taking advantage of the added strength provided by metal components.

### BRIEF DESCRIPTION

In one aspect, a laminated composite airfoil assembly is provided. The airfoil assembly includes a first lamina formed of a pre-preg material including metal fibers, and at least a second lamina formed of a pre-preg material including at least one of metal fibers intermixed with carbon fibers, only metal fibers, only carbon fibers, a substrate including metal fibers, a substrate including carbon fibers, and combinations thereof.

The airfoil assembly may include additional, fewer, and/or alternative elements. In some embodiments, the metal fibers include at least one of annealed steel, a nickel alloy, a nickel and chromium alloy, titanium, tungsten, and combinations thereof. In some embodiments, the second lamina is formed from a different pre-preg material than the first lamina. In some embodiments, the first lamina is formed from a pre-preg material including the metal fibers oriented in a first direction and the second lamina is formed from a pre-preg material including carbon fibers oriented in a second direction. The first lamina may be formed from a pre-preg material including unidirectional metal fibers oriented in the first direction, and the second lamina may be formed from a pre-preg material including unidirectional carbon fibers oriented in the second direction. In some embodiments, one of the first lamina and the second lamina is formed from a pre-preg material including unidirectional carbon fibers oriented in a first direction and metal fibers crisscrossing the carbon fibers. In other embodiments, the airfoil assembly includes a plurality of laminae formed from pre-preg materials including the first lamina and the second lamina, and a subset of laminae of the plurality of laminae are formed from pre-preg material including carbon fibers. The airfoil assembly may further include metal threads extending into the subset of the plurality of laminae. The metal threads may extend into the subset of the plurality of laminae in a 2.5D configuration, or the metal threads may extend into the subset of the plurality of laminae in a 3D configuration.

In another aspect, a method of forming a laminated composite airfoil assembly is provided. The method includes providing a first lamina formed of a pre-preg material including metal fibers, and positioning a second lamina adjacent the first lamina, the second lamina formed of a pre-preg material including at least one of metal fibers intermixed with carbon fibers, only metal fibers, only carbon fibers, a substrate including metal fibers, a substrate including carbon fibers, and combinations thereof. The method also includes curing at least the first and second laminae to form the laminated composite airfoil assembly.

The method may include additional, fewer, and/or alternative steps. For example, in some embodiments, providing the first lamina includes providing the first lamina formed of a pre-preg material including metal fibers oriented in a first direction, and positioning the second lamina includes positioning the second lamina formed of a pre-preg material including carbon fibers oriented in a second direction. In some embodiments, the laminated composite airfoil assembly includes a plurality of laminae formed from pre-preg material including the first and second laminae, and wherein a subset of laminae of the plurality of laminae includes laminae formed from pre-preg material including carbon fibers, and the method further includes threading metal threads into the subset of the plurality of laminae. Threading metal threads into the subset of the plurality of laminae may include threading the metal threads in a 2.5D configuration, or threading metal threads into the subset of the plurality of laminae may include threading the metal threads in a 3D configuration.

In a further aspect, an engine is provided. The engine includes a core engine, and a fan powered by the core engine. The fan includes at least one laminated composite airfoil assembly. The laminated composite airfoil assembly includes a first lamina formed of a pre-preg material including metal fibers, and at least a second lamina formed of a pre-preg material including at least one of metal fibers intermixed with carbon fibers, only metal fibers, only carbon fibers, a substrate including metal fibers, a substrate including carbon fibers, and combinations thereof

The engine and/or the airfoil assembly may include additional, fewer, and/or alternative elements. In some embodiments, the metal fibers include at least one of annealed steel, a nickel alloy, a nickel and chromium alloy, titanium, tungsten, and combinations thereof. In some embodiments, the second lamina is formed from a different pre-preg material than the first lamina. In some embodiments, the airfoil assembly includes a plurality of laminae formed from pre-preg materials including the first lamina and the second lamina, and wherein a subset of laminae of the plurality of laminae are formed from pre-preg material including carbon fibers, the airfoil assembly further including metal threads extending into the subset of the plurality of laminae. The metal threads may extend into the subset of the plurality of laminae in a 2.5D configuration, or the metal threads may extend into the subset of the plurality of laminae in a 3D configuration.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is an illustration of an exemplary aircraft in accordance with an example embodiment of the present disclosure;

FIG. 2 is a schematic illustration of an exemplary gas turbofan engine that may be used with the aircraft shown in FIG. 1;

FIG. 3 is a view of a first exemplary laminated airfoil assembly that may be used with the turbofan engine shown in FIG. 2;

FIG. 4 is a schematic illustration of a lamina that may be used with the laminated airflow assembly shown in FIG. 3;

FIG. 5 is a perspective view of a second exemplary laminated airfoil assembly that may be used with the turbofan engine shown in FIG. 2 including metal threads in a 2.5D configuration; and

FIG. 6 is a perspective view of a third exemplary laminated airfoil assembly that may be used with the turbofan engine shown in FIG. 2 including metal threads in a 3D configuration.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “axial” and “axially” refer to directions and orientations that extend substantially parallel to a centerline of an engine. Moreover, the terms “radial” and “radially” refer to directions and orientations that extend substantially perpendicular to the centerline of the engine. In addition, as used herein, the terms “circumferential” and “circumferentially” refer to directions and orientations that extend arcuately about the centerline of the engine.

The following description refers to the accompanying drawings, in which, in the absence of a contrary representation, the same numbers in different drawings represent similar elements.

Embodiments of the laminated airfoil assemblies described herein provide a cost-effective system for reducing the weight of composite engine blades (e.g., fan blades) while maintaining the strength advantages of adding metal thereto. Metal elements are provided within the pre-preg material that forms one or more laminae of the laminated airfoil assembly, and the amount and location of the metal elements may be selected according to the specific design needs of each blade. In addition, in some embodiments, metal fibers are woven into the laminated airfoil assembly to improve the strength and impact resistance of the airfoil while mitigating added weight thereto.

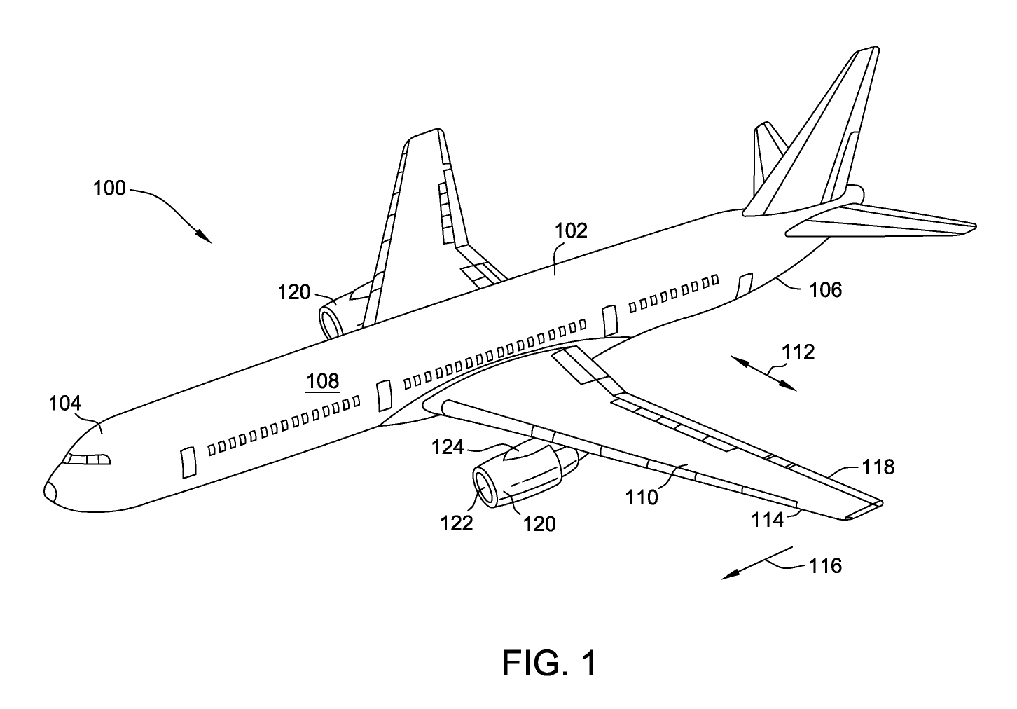

FIG. 1 is a perspective view of an aircraft 100. In the example embodiment, aircraft 100 includes a fuselage 102 that includes a nose 104, a tail 106, and a hollow, elongate body 108 extending therebetween. Aircraft 100 also includes a wing 110 extending away from fuselage 102 in a lateral direction 112. Wing 110 includes a forward leading edge 114 in a direction 116 of motion of aircraft 100 during normal flight and an aft trailing edge 118 on an opposing edge of wing 110. Aircraft 100 further includes at least one engine 120, such as, but not limited to a turbofan engine, configured to drive a bladed rotatable member, such as, fan 122 to generate thrust. Engine 120 is connected to an engine pylon 124, which may connect engine 120 to aircraft 100. Engine pylon 124, for example, may couple engine 120 to at least one of wing 110 and fuselage 102, for example, in a pusher configuration (not shown) proximate tail 106.

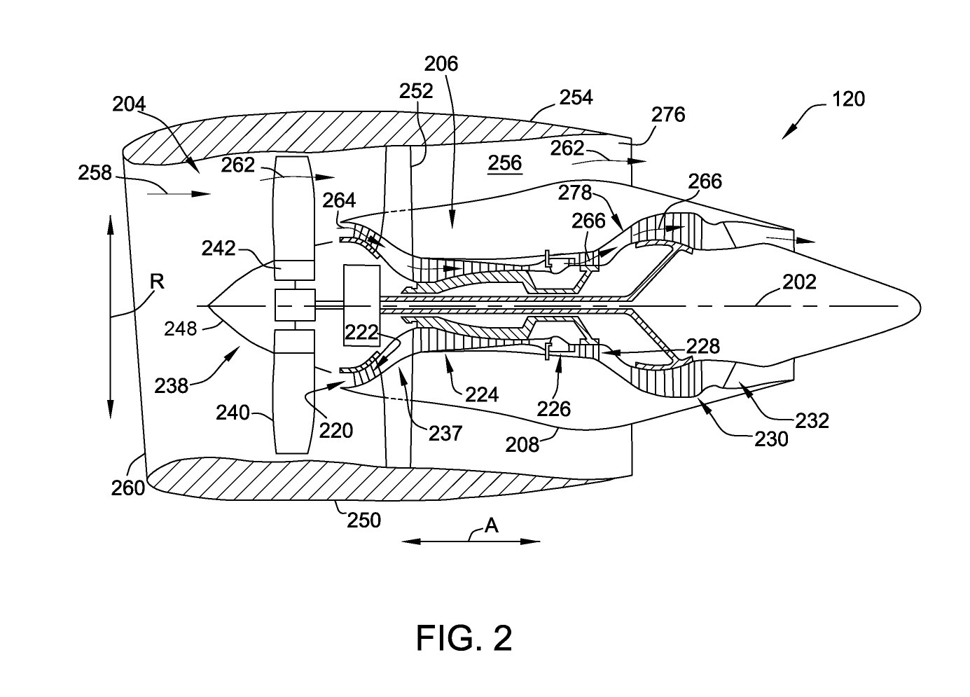

FIG. 2 is a schematic cross-sectional view of engine 120 (as shown in FIG. 1) in accordance with an exemplary embodiment of the present disclosure. In the example embodiment, engine 120 is embodied in a high-bypass turbofan jet engine. As shown in FIG. 2, engine 120 defines an axial direction A (extending parallel to a longitudinal axis 202 provided for reference) and a radial direction R. In general, engine 120 includes a fan assembly 204 and a core turbine engine 206 disposed downstream from fan assembly 204.

In the example embodiment, core turbine engine 206 includes an engine case 208 that defines an annular inlet 220. Engine case 208 at least partially surrounds, in serial flow relationship, a compressor section including a booster or low pressure (LP) compressor 222 and a high pressure (HP) compressor 224; a combustion section 226; a turbine section including a high pressure (HP) turbine 228 and a low pressure (LP) turbine 230; and a jet exhaust nozzle section 232. The compressor section, combustion section 226, turbine section, and jet exhaust nozzle section 232 together define a core air flowpath 237.

In the example embodiment, fan assembly 204 includes a fan 238 having a plurality of fan blades 240, also referred to herein as “airfoil assemblies” 240, coupled to a disk 242 in a spaced apart relationship. Airfoil assemblies 240 extend radially outwardly from disk 242. Disk 242 is covered by rotatable front hub 248 aerodynamically contoured to promote an airflow through the plurality of airfoil assemblies 240. Additionally, fan assembly 204 includes an annular fan casing or outer nacelle 250 that circumferentially surrounds fan 238 and/or at least a portion of core turbine engine 206. In the example embodiment, nacelle 250 is configured to be supported relative to core turbine engine 206 by a plurality of circumferentially-spaced outlet guide vanes 252. Moreover, a downstream section 254 of nacelle 250 may extend over an outer portion of core turbine engine 206 so as to define a bypass airflow passage 256 therebetween.

During operation of engine 120, a volume of air 258 enters engine 120 through an associated inlet 260 of nacelle 250 and/or fan assembly 204. As volume of air 258 passes across airfoil assemblies 240, a first portion 262 of volume of air 258 is directed or routed into bypass airflow passage 256 and a second portion 264 of volume of air 258 is directed or routed into core air flowpath 237, or more specifically into LP compressor 222. A ratio between first portion 262 and second portion 264 is commonly referred to as a bypass ratio. The pressure of second portion 264 is then increased as it is routed through high pressure (HP) compressor 224 and into combustion section 226, where it is mixed with fuel and burned to provide combustion gases 266.

Combustion gases 266 are routed through HP turbine 228 where a portion of thermal and/or kinetic energy from combustion gases 266 is extracted to drive a rotation of HP compressor 224. Combustion gases 266 are then routed through LP turbine 230 where a second portion of thermal and kinetic energy is extracted from combustion gases 266 to drive rotation of LP compressor 222 and/or rotation of fan 238.

Combustion gases 266 are subsequently routed through jet exhaust nozzle section 232 of core turbine engine 206 to provide propulsive thrust. Simultaneously, the pressure of first portion 262 is substantially increased as first portion 262 is routed through bypass airflow passage 256 before it is exhausted from a fan nozzle exhaust section 276 of engine 120, also providing propulsive thrust. HP turbine 228, LP turbine 230, and jet exhaust nozzle section 232 at least partially define a hot gas path 278 for routing combustion gases 266 through core turbine engine 206.

Turbofan engine 120 is depicted in the figures by way of example only, in other exemplary embodiments, turbofan engine 120 may have any other suitable configuration including for example, a turboprop engine, a military purpose engine, and a marine or land-based aero-derivative engine.

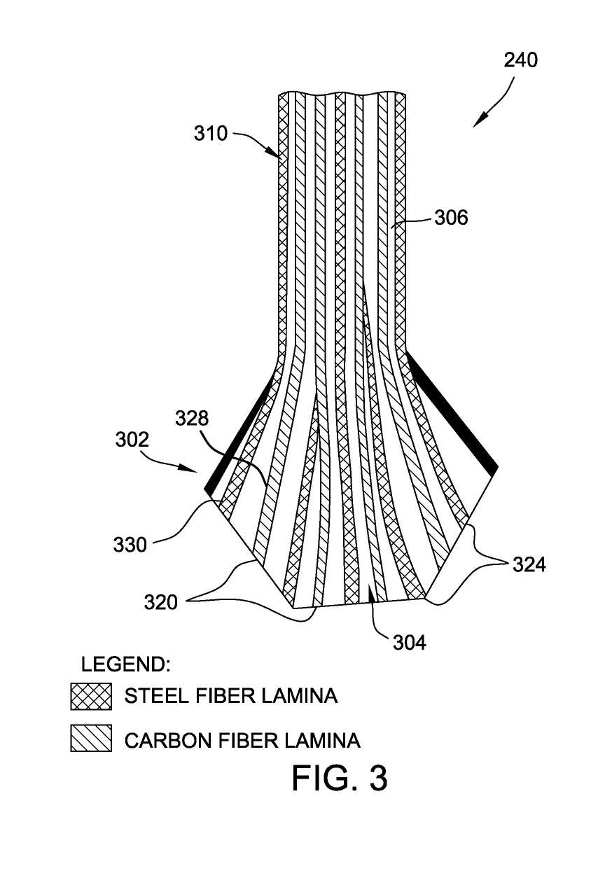

FIG. 3 is a view of a first exemplary laminated airfoil assembly 240 that may be used with turbofan engine 120 (shown in FIG. 2). It should be understood that although the following discussion is directed to airfoil assemblies 240 of fan 238 (shown in FIG. 2), the present disclosure is applicable to blade or airfoil assemblies in any rotating engine or machinery component. In the illustrated embodiment, airfoil assembly 240 extends from a dovetail 302 configured to engage disk 242 (shown in FIG. 2) of fan 238. A blade root 304 is coupled to and formed radially outward from dovetail 302. Airfoil assembly 240 further includes an airfoil 306 with a tip (not shown) at a distal radial end thereof.

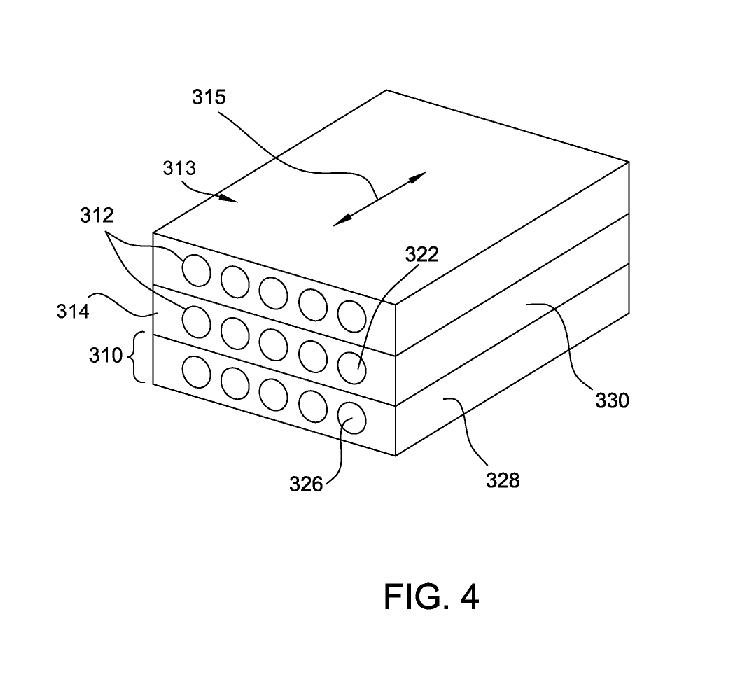

In the illustrated embodiment, airfoil assembly 240 is a laminated airfoil assembly. A “laminated” airfoil assembly, as referred to herein, is fabricated using a plurality of plies or lamina 310, as illustrated in FIG. 4. With reference to FIGS. 3 and 4, each lamina 310 includes a plurality of fibers 312 of at least one material extending in one direction 315, or “unidirectional fibers” 312. Fibers 312 are surrounded by a resin or substrate 314, such that laminae 310 are referred to as “impregnated” with fibers 312, or as formed from “pre-preg” material 313 including fibers 312 and substrate 314. Pre-preg material is distinguished from a “woven” material in that woven material has fibers woven dry, or without resin, and resin is added over the woven fibers.

Airfoil assembly 240 is fabricated from a plurality of lamina 310 including fibers 312 of varying materials. More specifically, airfoil assembly 240 includes at least one lamina 310 (e.g., a first lamina 328) formed of a pre-preg material 313 including metal fibers 326, and at least one lamina 310 (e.g., a second lamina 330) formed of a pre-preg material 313 including at least one of metal fibers 326 intermixed with carbon fibers 322, only metal fibers 326, only carbon fibers 322, a substrate 314 comprising metal fibers 326, a substrate 314 comprising carbon fibers 322, and combinations thereof. In the illustrated embodiments, a subset 320 of the plurality of lamina 310 include carbon fibers 322, or any other non-metallic fibers, and a subset 324 of the plurality of lamina 310 include metal fibers 326, wherein metal fibers 326 include at least one of annealed steel, a nickel alloy, a nickel and chromium alloy, titanium, tungsten, and combinations thereof. Alternative embodiments of metal fibers 326 may include additional and/or alternative metals. In some cases, one or more of lamina 310 includes unidirectional carbon fibers 322 with metal fibers 326 criss-crossing the carbon fibers 322.

To form airfoil assembly 240, the plurality of laminae 310 are positioned such that fibers 312 are oriented at particular angles with respect to airfoil assembly 240 as a whole and/or with respect to adjacent laminae 310. For example, a first lamina 328 including metal fibers 326 is cut into a desired shape and positioned such that metal fibers 326 extend in a first direction (not specifically shown). A second lamina 330 including carbon fibers 322 (or a combination of metal fibers 326 and carbon fibers 322) is cut into a desired shape and positioned adjacent first lamina 328, and with carbon fibers 322 extending in a second direction (not specifically shown). In some cases, the first direction and the second direction are substantially similar (e.g., less than 1° of difference). In other cases, the first direction and the second direction are not substantially similar, and the second direction is oriented at a predetermined angle with respect to the first direction. Once the plurality of laminae 310 are positioned as desired, laminae 310 are cured to complete airfoil assembly 240.

Forming laminated airfoil assemblies 240 with laminae 310 including metal fibers 326 facilitates improving ductility over fully carbon fiber airfoil assemblies, and increasing a failure strain of laminated airfoil assemblies 240. In other words, replacing at least some of carbon fibers 322 with metal fibers 326 enables airfoil assembly 240 to flex more without failing, for instance, in an impact event. Notably, laminated airfoil assembly 240 is formed with selective addition of metal fibers 326 into one or more laminae 310 and/or selective addition of laminae 310 including only metal fibers 326, such that the location of metal fibers 326 is tailored to the particular design needs of airfoil assembly 240. Depending on the design needs of airfoil assembly 240, the amount and/or location of metal fibers 326 and/or laminae 310 including metal fibers 326 are selected to improve the failure strain and impact resistance of airfoil assembly 240. Accordingly, due to the customizability of airfoil assembly 240, the need for exterior-bonded metal pieces is reduced or eliminated, thereby facilitating the formation of airfoil assemblies 240 with reduced weight and/or decreased thickness when compared to full-carbon airfoils with exterior metal pieces. Reducing airfoil weight in turn reduces an overall engine weight, improving efficiency and fuel consumption.

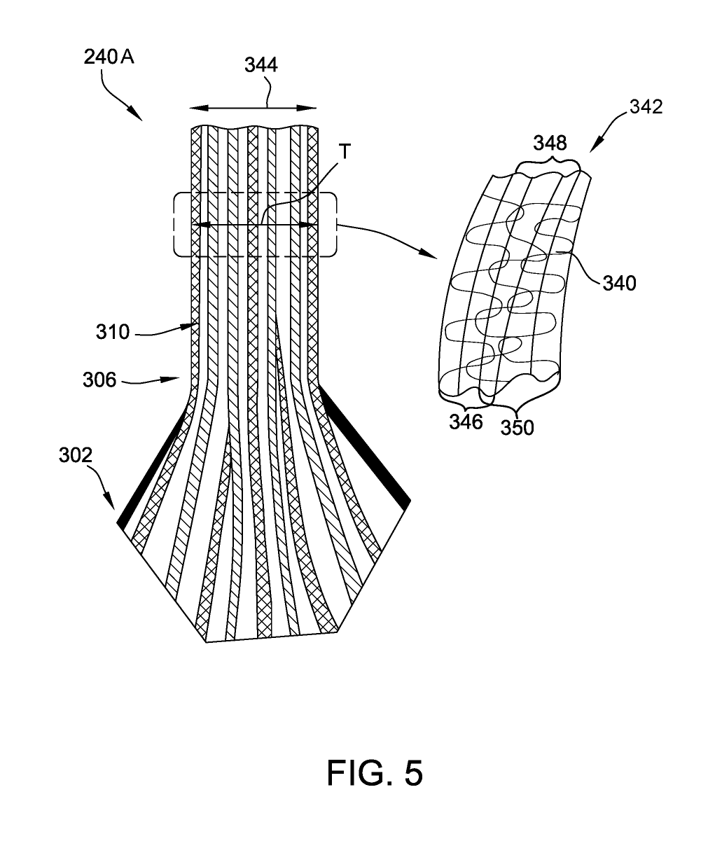

FIG. 5 is a perspective view of a second exemplary laminated airfoil assembly 240A that may be used with turbofan engine 120 (shown in FIG. 2). In the illustrated embodiment, airfoil assembly 240A is constructed using one or more metal threads 340 extending through laminae 310 in a 2.5D configuration 342. More specifically, the one or more metal threads 340 extend in a thickness direction 344 through laminae 310 from dovetail 302 to the tip (not shown) of airfoil assembly 240A. 2.5D configuration 342 is characterized by one or more metal threads 340 extending less than a full thickness distance T through airfoil 306. In the illustrated embodiment, metal threads 340 extend through a first subset 346 of laminae 310 for one portion of thickness T, through a second subset 348 of laminae 310 for another portion of thickness T, and through a third subset 350 of laminae 310 for another portion of thickness T, wherein the first, second, and/or third subsets 346, 348, 350 may include one or more of the same laminae 310, and wherein the portions of thickness T may overlap. In another embodiment, some metal threads 340 may extend through substantially half of laminae 310 at particular locations along airfoil 306 (e.g., substantially ½ T), and other metal threads 340 may extend through substantially the other half of laminae 310 at other particular locations along airfoil 306. Other implementations of 2.5D configuration 342 are contemplated within the scope of the present disclosure (e.g., more metal threads 340 extending through varying subsets of laminae 310).

In some embodiments, airfoil assembly 240A is fabricated from laminae 310 including only carbon fibers 322. In other embodiments, airfoil assembly 240A is fabricated from a plurality of varying types of laminae 310. In other words, the threading of metal threads 340 in 2.5D configuration 342 may be implemented on airfoil assemblies 240 with or without internal metal fibers 326.

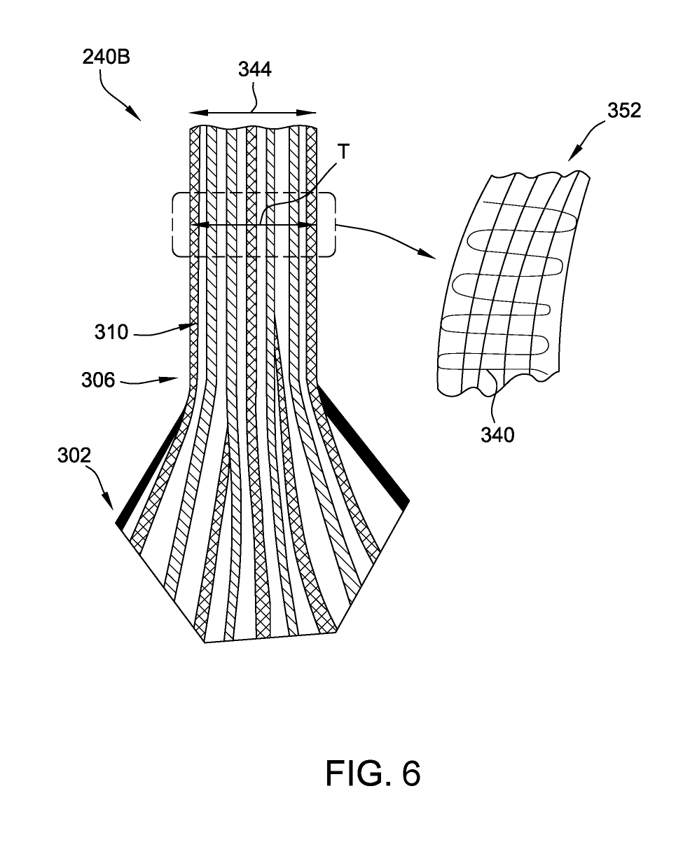

FIG. 6 is a perspective view of a third exemplary laminated airfoil assembly 240B that may be used with turbofan engine 120 (shown in FIG. 2). In the illustrated embodiment, airfoil assembly 240B is constructed using one or more metal threads 340 extending through laminae 310 in a 3D configuration 352. More specifically, the one or more metal threads 340 extend in thickness direction 344 through laminae 310 from dovetail 302 to the tip (not shown) of airfoil assembly 240B. 3D configuration 352 is characterized by one or more metal threads 340 extending the full thickness distance T through airfoil 306. In other words, metal threads 340 extend in thickness direction 344 through substantially all of laminae 310.

In some embodiments, airfoil assembly 240B is fabricated from laminae 310 including only carbon fibers 322. In other embodiments, airfoil assembly 240B is fabricated from a plurality of varying types of laminae 310. In other words, the threading of metal threads 340 in 3D configuration 352 may be implemented on airfoil assemblies 240 with or without internal metal fibers 326. In the example embodiment, metal threads 340 are threaded through laminae 310 prior to curing laminae 310 to form airfoil assembly 240A and/or 240B.

The above-described laminated airfoil assemblies provide an efficient method for improving ductility and impact resistance of fan airfoil assemblies while reducing the weight thereof. Specifically, airfoil assemblies include metal fibers and/or metal threads selectively added to and/or replacing carbon fibers within laminated airfoil assemblies, facilitating reducing or eliminating the need for exterior-bonded metal pieces.

Exemplary embodiments of laminated airfoil assemblies are described above in detail. The airfoil assemblies, and methods of forming and/or operating the same, are not limited to the specific embodiments described herein, but rather, components of the airfoil assemblies and/or steps of the methods may be utilized independently and separately from other components and/or steps described herein. Rather, the exemplary embodiment can be implemented and utilized in connection with many other machinery applications that have bladed, rotating components.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A laminated composite airfoil assembly comprising:
a first lamina formed of a pre-preg material comprising metal fibers; and
at least a second lamina formed of a pre-preg material comprising at least one of metal fibers intermixed with carbon fibers, only metal fibers, only carbon fibers, a substrate comprising metal fibers, a substrate comprising carbon fibers, and combinations thereof.

2. The airfoil assembly of claim 1, wherein said metal fibers comprise at least one of annealed steel, a nickel alloy, a nickel and chromium alloy, titanium, tungsten, and combinations thereof.

3. The airfoil assembly of claim 1, wherein said second lamina is formed from a different pre-preg material than said first lamina.

4. The airfoil assembly of claim 1, wherein said first lamina is formed from a pre-preg material comprising said metal fibers oriented in a first direction and said second lamina is formed from a pre-preg material comprising carbon fibers oriented in a second direction.

5. The airfoil assembly of claim 4, wherein said first lamina is formed from a pre-preg material comprising unidirectional metal fibers oriented in the first direction and said second lamina is formed from a pre-preg material comprising unidirectional carbon fibers oriented in the second direction.

6. The airfoil assembly of claim 1, wherein one of said first lamina and said second lamina is formed from a pre-preg material comprising unidirectional carbon fibers oriented in a first direction and metal fibers crisscrossing the carbon fibers.

7. The airfoil assembly of claim 1, wherein said airfoil assembly comprises a plurality of laminae formed from pre-preg materials including said first lamina and said second lamina, and wherein a subset of laminae of said plurality of laminae are formed from pre-preg material comprising carbon fibers, said airfoil assembly further comprising metal threads extending into said subset of said plurality of laminae.

8. The airfoil assembly of claim 7, wherein said metal threads extend into said subset of said plurality of laminae in a 2.5D configuration.

9. The airfoil assembly of claim 7, wherein said metal threads extend into said subset of said plurality of laminae in a 3D configuration.

10. A method of forming a laminated composite airfoil assembly comprising:
providing a first lamina formed of a pre-preg material including metal fibers; and
positioning a second lamina adjacent the first lamina, the second lamina formed of a pre-preg material including at least one of metal fibers intermixed with carbon fibers, only metal fibers, only carbon fibers, a substrate including metal fibers, a substrate including carbon fibers, and combinations thereof; and
curing at least the first and second laminae to form the laminated composite airfoil assembly.

11. The method of claim 10, wherein providing the first lamina comprises providing the first lamina formed of a pre-preg material including metal fibers oriented in a first direction, and wherein positioning the second lamina comprises positioning the second lamina formed of a pre-preg material including carbon fibers oriented in a second direction.

12. The method of claim 10, wherein the laminated composite airfoil assembly includes a plurality of laminae formed from pre-preg material including the first and second laminae, and wherein a subset of laminae of the plurality of laminae includes laminae formed from pre-preg material including carbon fibers, said method further comprising threading metal threads into the subset of the plurality of laminae.

13. The method of claim 12, wherein threading metal threads into the subset of the plurality of laminae comprises threading the metal threads in a 2.5D configuration.

14. The method of claim 12, wherein threading metal threads into the subset of the plurality of laminae comprises threading the metal threads in a 3D configuration.

15. An engine comprising:
a core engine; and
a fan powered by gas generated in said core engine,
wherein said fan comprises at least one laminated composite airfoil assembly, said laminated composite airfoil assembly comprising:
a first lamina formed of a pre-preg material comprising metal fibers; and
at least a second lamina formed of a pre-preg material comprising at least one of metal fibers intermixed with carbon fibers, only metal fibers, only carbon fibers, a substrate comprising metal fibers, a substrate comprising carbon fibers, and combinations thereof.

16. The engine of claim 15, wherein said metal fibers comprise at least one of annealed steel, a nickel alloy, a nickel and chromium alloy, titanium, tungsten, and combinations thereof.

17. The engine of claim 15, wherein said second lamina is formed from a different pre-preg material than said first lamina.

18. The engine of claim 17, wherein said airfoil assembly comprises a plurality of laminae formed from pre-preg materials including said first lamina and said second lamina, and wherein a subset of laminae of said plurality of laminae are formed from pre-preg material comprising carbon fibers, said airfoil assembly further comprising metal threads extending into said subset of said plurality of laminae.

19. The engine of claim 18, wherein said metal threads extend into said subset of said plurality of laminae in a 2.5D configuration.

20. The engine of claim 18, wherein said metal threads extend into said subset of said plurality of laminae in a 3D configuration.
